(19) United States
(12) Patent Application Publication
(10) Pub. No.: US 2019/0011702 A1
(43) Pub. Date: Jan. 10, 2019

(54) Helmet-Mounted Visualization Device Without Parallax and its Operation Method

(71) Applicant: RAVR Incorporation Ltd., Road Town (VG)

(72) Inventor: Evan Y. W. Zhang, Hangzhou City (CN)

(21) Appl. No.: 15/642,407

(22) Filed: Jul. 6, 2017

(51) Int. Cl. G02B 27/01; H04N 5/33; H04N 7/18; F41H 1/04; A42B 3/04

(52) U.S. Cl. CPC G02B 27/0172; G02B 27/0176; H04N 5/332; A42B 3/042; H04N 7/185; F41H 1/04; G02B 27/0179

(57) ABSTRACT

A helmet-mounted visualization device without parallax and its operation method are provided in the present disclosure. The helmet-mounted visualization device includes a fixing member, a first unit, a photoelectric part, a second unit, and a connecting member. The first unit at least includes an objective lens and a display element. The photoelectric part is used for converting an external optical signal passing through the objective lens into an electrical signal and transmitting the electrical signal to a processing circuit. The second unit includes the processing circuit and a power supply and may include the photoelectric part. The connecting member is made of a bendable metal material or a mechanical device and is shaped into a fixed shape when the central axis of the objective lens is collinear with the central axis of the display element and the user's eye sight. The user can use one eye or two eyes.

### FIELD OF THE DISCLOSURE

The present disclosure relates to an imaging technology, and more particularly to a helmet-mounted visualization device without parallax and its operation method.

### BACKGROUND OF THE INVENTION

Currently, all kinds of infrared/night-vision helmet-mounted visualization device or CCD/CMOS system are mounted on the top of the helmet above the helmet tongue or near the ears, but display devices, such as LCD/OLED and other displays must be placed below the helmet tongue and in the front of user's eyes, thus the helmet-mounted visualization device will have a huge parallax. Due to the huge parallax, the location of a target in 3D space from infrared camera is quite different from the user's eyes, which causes difficult during user's walking and working. For example, a firefighter will fall from the burning floor because of a miss step; during the night a soldier cannot use the IR image to shoot the enemy because the bullet will fly to somewhere due to the large angle difference between the gun aiming sight and the IR viewing sight; since the parachuter cannot define a clear border between water and shore, he might jump into the river; and so on.

In order to eliminate parallax, an improved scheme is proposed by the applicant in the present disclosure. In particular: a thermal imaging unit is placed in front of the face mask, and a display element is placed behind the unit and in a straight line with the eye to eliminate the parallax. Please refer to previous Patent CN100509086C, that patent is inadequate, such as: the display element is placed within the mask and cannot be moved, this may block the user's vision when the thermal imager is not in use, and the available volume and air flow inside the mask will be reduced due to the display element.

According to Patent CN201520395217.7, a helmet-mounted night-vision thermal imager is proposed. The specific scheme is that: a thermal imager composed by a lens, a focal plane array, a processing circuit board, a LCD screen, a backlight, a drive board, and an eyepiece are stacked together to eliminate the parallax. But this scheme is also inadequate. For example, a height of the device is more than 10 centimeters, like an elephant nose stretched out the mask, it is difficult to be accepted by the user. In order to reduce the height of the device outside of the mask, a special mask with concave shape in the front of the eye portion is proposed. Since the IR imager is closer to the user's eyes it may increase the risk if the mask is crushed or burned, and the internal space and air flow inside the mask are reduced because a portion of mask is sunken, and thus it is difficult to pass mask inspection standards. Another drawback of placing the sunken mask close to the user's eyes is that: more area of the stereoscopic viewing is blocked by the display element, so that the surrounding object is not easy to be seen. Re-model the mask not only will increase the cost, but also it is impossible to use an existing mask for the IR imager in an emergency situation, thus making it difficult to be accepted by the user. In addition, according to the patent, the battery is placed below the helmet tongue, which is not inappropriate. If the Li-ion battery is exploded or burned near the user's head, it will cause a life-threatening issue. Therefore, the battery must be placed on a metal housing outside of the helmet for safe consideration.

Hence, how to eliminate parallax of the helmet-mounted visualization device has become an important topic for the person skilled in the art.

### SUMMARY OF THE INVENTION

Based on the above discussion, in order to solve the above-mentioned deficiencies in the conventional solutions, a helmet-mounted visualization device without parallax, easy to use, and having little impact to vision is provided in the present disclosure.

It is one objective of the present disclosure to provide a helmet-mounted visualization device without parallax.

According to one exemplary embodiment of the present disclosure, a helmet-mounted visualization device without parallax is provided. The helmet-mounted visualization device includes a fixing member, a first unit, a photoelectric part, a second unit, and a connecting member. The fixing member is adapted to be worn on a user's head. The first unit includes an IR objective lens and a photoelectric part which includes or not includes a focal plan array and a readout circuit, and a LCD/OLED display screen with an eye piece; in the front of the user's eyes, the central axis of the objective lens and the central axis of the eye piece are in a straight line without parallax. The photoelectric part containing the IR focal plan array and the readout circuit is used for converting an external optical signal passing through the objective lens into an electrical signal and transmitting the signal to a processing unit. The second unit at least includes the IR signal processing circuit, the display circuit and the power supply, wherein an output end of the IR processing circuit is coupled to the display circuit; and the display circuit is connected to the display screen which is in the front of the eye piece. The second unit is disposed on the fixing member above the helmet tongue so it will not block user's vision. The connecting member couples the first unit and the second unit. The connecting member is made of a bendable metal material with optic or electronic signal transmitting medium inside.

In one example, the photoelectric part containing the IR focal plan array and the readout circuit is disposed within the first unit, and the electrical signal is transmitted to the processing circuit through the cable transmission medium.

In one example, the photoelectric part is disposed within the second unit, which contains the IR focal plan array and the readout circuit, and the transmission medium includes an optical fiber bundle or a mirror with relay optics. The external optical signal passing through the objective lens is received by the optical fiber bundle or a mirror with relay optics and transmitted to the photoelectric part. An electrical cable is used for connecting the processing circuit and the display circuit.

In one example, the connecting member is a metal tube such as a metal corrugated tube, and the transmission medium passes through the metal tube.

In one example, the connecting member is a metal strip, and the transmission medium is fixed to an outer wall of the connecting member.

In one example, the fixing member is a mechanic gear on a military helmet or a fireman helmet or a head-worn device, and the second unit with an envelope is fixed on the gear of the military helmet or the fireman helmet or the head-worn device.

In one example, the military helmet or the fireman helmet or the head-worn device is connected with a protective cover such as a face mask; the first unit is disposed on the outside of the protective cover, or the moveable display element is disposed on the inside of the protective cover but the objective lens with the photoelectric part is disposed on the outside of the protective cover.

In one example, the helmet-mounted visualization device is applied for external imaging in a temperature measurement, or in a no light, lowlight, and smoke environment.

In one example, the infrared (IR) image or visible (VIS) image or their fusion image picture in picture or pixel by pixel with voice of the user is encrypted with the GPS location and sent to the rear headquarter and the headquarter also can send the encrypted video and voice to the front soldier and fireman. Since the IR image is a thermal image not as clear as the visible image, and we are only interested in the high temperature or low temperature portion, so we will setup a threshold for the thermal image such as higher than 30° C., if the field of view of the thermal imager and the visible camera is same, we will only use or overlap the pixels of the thermal image higher than the threshold (the values of the other IR pixels will be set to zero) to replace the corresponding pixels of the visible image not others, so we can see a clear visible image with high temperature thermal pixels or image overlapped. If we overlap the whole IR image on the whole VIS image with percentage (such as IR 70%, visible 30%) the fused image will be blur because the IR image is not clear. If the field of view of IR and VIS is different, we must scale and interpret the IR or VIS pixels to let them have the same image size then we can make the pixel by pixel fusion.

It is one objective of the present disclosure to provide a method for operating a helmet-mounted visualization device without parallax.

According to one exemplary embodiment of the present disclosure, a method for operating a helmet-mounted visualization device without parallax is provided. The helmet-mounted visualization device includes a fixing member, a first unit having an objective lens and a display element, with or without a photoelectric part depending on signal transmission electronically or optically, a second unit having a signal processing circuit, a display circuit and a power supply, with or without a photoelectric part depending on signal transmission electronically or optically, and a connecting member coupled between the first unit and the second unit. The method includes the following steps: when the fixing member of the helmet-mounted visualization device is worn on a user's head, turning on a power supply of the second unit; adjusting the connecting member in order to adjust a distance and position between the first unit and the second unit and the distance and position between the user's eyes and the eye piece, wherein the connecting member is made of a bendable metal material.

Compared with the prior art, the present disclosure has the following advantages:

[1] The first unit and the second unit are separately designed, such that the second unit containing the large processing circuit, display circuit and the power supply will not block the user's vision, and the first unit containing the objective lens with or without the photoelectric part has a height of only 2-3 cm and will only slightly affect the user's vision. There is no parallax between user's eye and objective lens, which is easy to walk and work. If the function is not in use, the first unit can be pulled up in order not to block the user's vision.

[2] When the helmet-mounted visualization device without parallax of the present disclosure is worn on a user's head, the connecting member is located above the nose bridge of the user. The first unit can be moved to the left or to the right in order to make the user use his left eye or right eye for observation, thereby facilitating different users.

[3] The external input signal can be thermal, visible or their fusion with picture in picture or pixel by pixel format, the encrypted video and voice with GPS location can be transmitted to the rear headquarter and the headquarter also can send the encrypted video and voice to the front soldier and fireman.

[4] The display element can be put inside of the face mask to get a large virtual reality screen of more than 60 inches, when the helmet-mounted visualization device is not in use, by moving the connection member with the magnetic case of the first unit to the side of the face mask, the thin metal case of the display element also will be moved to the side so the user's vision will not be blocked.

[5] The helmet-mounted visualization device without parallax of the present disclosure has a wide range of applications, which can be applied for external imaging in a temperature measurement, or in a no light, low light, and smoke environment.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an architecture diagram of a helmet-mounted visualization device without parallax according to an embodiment of the present disclosure.

FIG. 2 is a block diagram of a helmet-mounted visualization device without parallax according to an embodiment of the present disclosure.

FIG. 3 is a flowchart illustrating the procedures of a method for operating a helmet-mounted visualization device without parallax according to an embodiment of the present disclosure.

FIG. 4 is a picture of the helmet-mounted visualization device with IR and VIS image fusion.

FIG. 5 is a diagram of the fused IR and VIS images with a picture-in-picture format and wirelessly sent to the rear headquarter.

FIG. 6 is a diagram of the helmet-mounted visualization device without parallax and viewed by two eyes (binocular).

### DESCRIPTION OF THE PREFERRED EMBODIMENTS

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

In order to further explain the technical scheme of the helmet-mounted visualization device of the present invention in detail, a concrete example will be described below for describing the overall technical scheme and advantageous effects thereof.

### 1^{st} Embodiment

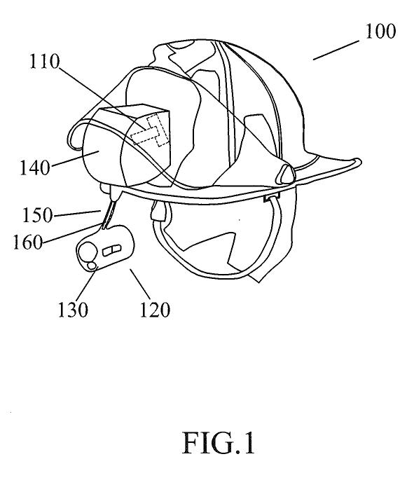

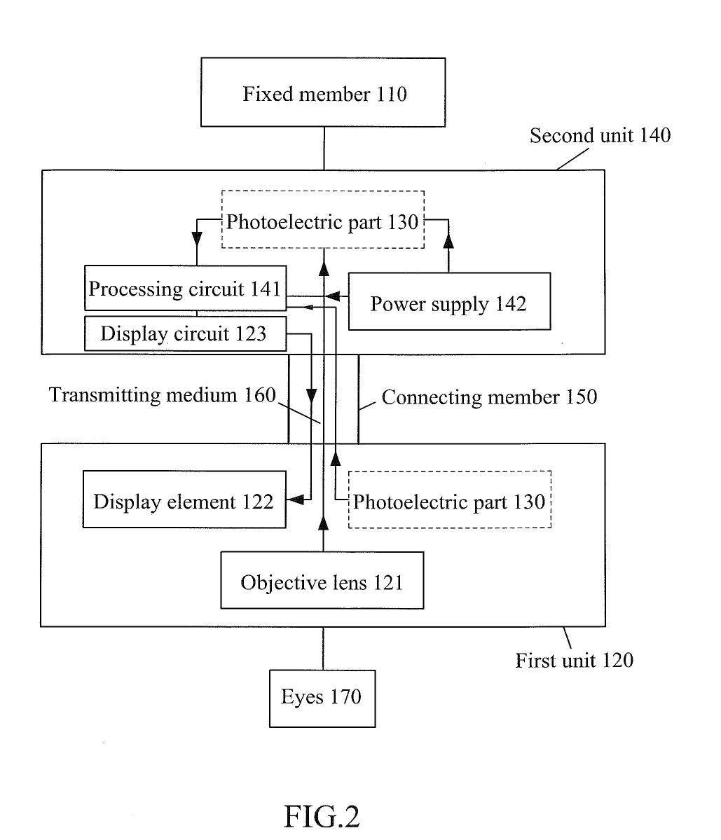

Please refer to FIG. 1 and FIG. 2. FIG. 1 is an architecture diagram of a helmet-mounted visualization device without parallax according to an embodiment of the present disclosure, and FIG. 2 is a block diagram of a helmet-mounted visualization device without parallax according to an embodiment of the present disclosure.

As shown in FIG. 1 and FIG. 2, the helmet-mounted visualization device 100 may include a fixing member 110, a first unit 120, a photoelectric part 130, a second unit 140, and a connecting member 150. The fixing member 110 is adapted to be worn on a user's head, such as a gear of a helmet. The first unit 120 at least includes an objective lens 121, and a display element 122. In one example, the photoelectric part 130 having a focal plan array and a readout circuit is disposed within the first unit 120, and the photoelectric part 130 is used for converting an external optical signal passing through the objective lens 121 into an electrical signal and transmitting the electrical signal to a processing circuit 141.

The second unit 140 includes a processing circuit 141, a display circuit 123 and a power supply 142, wherein an output end of the processing circuit 141 is coupled to the display circuit 123, and the display circuit 123 is coupled to the display screen 122 through a transmission medium 160. The second unit 140 is disposed on the fixing member 110 so as not to block the user's vision when it's in use.

The transmission medium 160, such as a cable, is arranged along the connecting member 150. For example, the transmission medium 160 is around the outer edge or the inside of the connecting member 150, depending on the structure of the connecting member 150. The transmission medium 160 is used for transmitting the electrical signal from the photoelectric part 130 to the processing circuit 141 and transmitting the output signal of the display circuit 123 to the display screen 122.

The connecting member 150 is made of a bendable material, such as a metal strip, a metal tube, or a metal corrugated tube. The connecting member 150 is coupled between the first unit 120 and the second unit 140. When in use, the first unit 120 is placed in front of the left eye or the right eye of the user; and when the first unit 120 is not used, the first unit 120 is pulled up above the eyes of the user and has no impact to the user's vision.

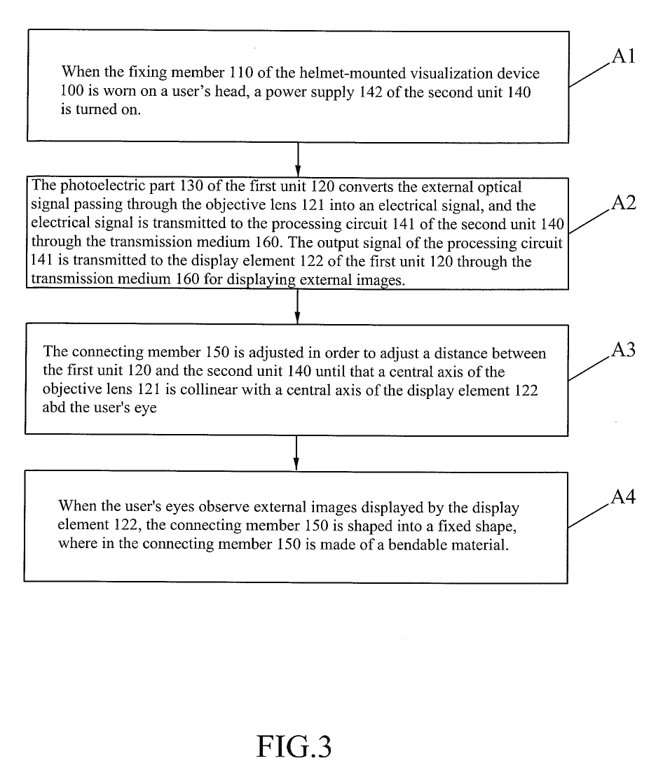

Please refer to FIG. 3. FIG. 3 is a flowchart illustrating the procedures of a method for operating a helmet-mounted visualization device without parallax according to a first embodiment of the present disclosure. As shown in FIG. 3, the method may include the following steps.

(A1) When the fixing member 110 of the helmet-mounted visualization device 100 is worn on a user's head, a power supply 142 of the second unit 140 is turned on.

(A2) The photoelectric part 130 of the first unit 120 converts the external optical signal passing through the objective lens 121 into an electrical signal, and the electrical signal is transmitted to the processing circuit 141 of the second unit 140 through the transmission medium 160. The output signal of the processing circuit 141 thus the output signal of the display circuit 123 is transmitted to the display element 122 of the first unit 120 through the transmission medium 160 for displaying external images.

(A3) The connecting member 150 is adjusted in order to adjust a distance and position between the first unit 120 and the second unit 140, and adjust a distance and position between the eye piece and the user's eyes.

(A4) The first unit 120 is moved such that the first unit 120 won't block the user's vision completely. When the user's eyes observe external images displayed by the display element 122 properly, the connecting member 150 is shaped into a fixed shape, wherein the connecting member 150 is made of a bendable metal material such as a corrugated tube.

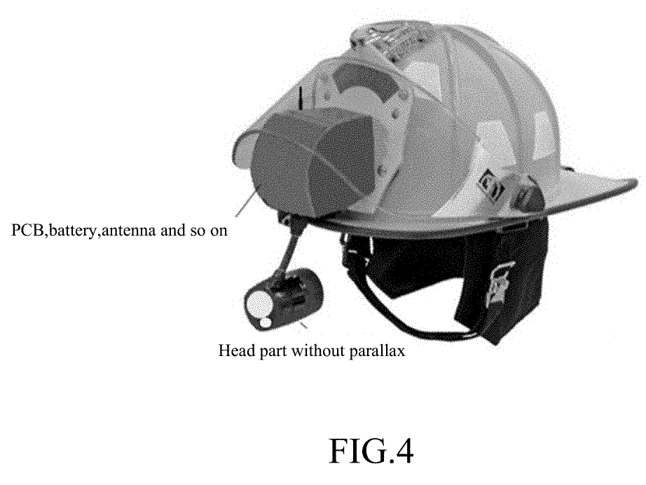

Please refer to FIG. 4. FIG. 4 is a picture of the helmet-mounted visualization device with IR and VIS image fusion. To overcome the parallax problem, as shown in FIG. 4, we put the small IR lens and the LCD display in the front of the user's eyes below the helmet, but put the large PCB and battery on a helmet, then use an internal wire or an optical method to link them through a flexible metal corrugated tube; the whole system can be put outside of a fire fighting face mask or used without a face mask. We use the optical or electrical method to send the images from the infrared lens to the circuit board on the helmet first to avoid the big board blocking the line of sight, then make a U turn to use electronic method to send the infrared images back to the LCD viewer behind the lens. Because the sizes of the lens and LCD/OLED are very small, the whole imaging head in the front of the user's eyes will not block the vision too much. If the LCD is close to the user's eyes within 2 cm, the user can see a 60″ large screen because of the virtual reality effect. Since the parallax is completely eliminated, soldiers can shoot the enemies according to the IR images at night.

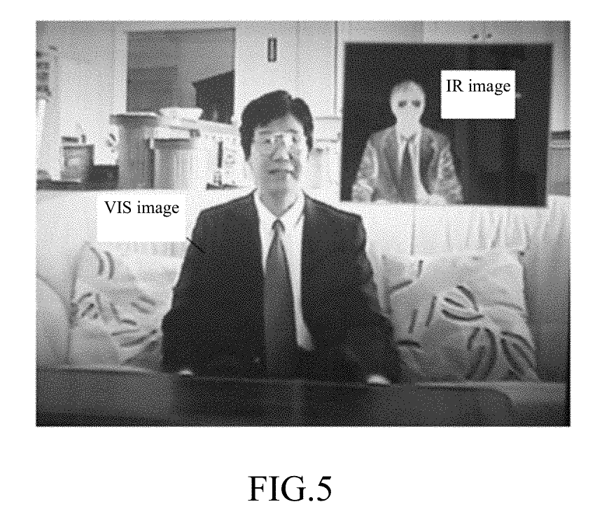

Please refer to FIG. 5. FIG. 5 is a picture of the fused IR and VIS images with a picture-in-picture format taken by the IR helmet and wirelessly sent to the rear headquarter. If the user pushes the camera head up, the whole system will be fixed on the space by the gear and will not block his vision at all.

### 2^{nd} Embodiment

The differences between the helmet-mounted visualization devices in the 2^{nd} Embodiment and the 1^{st} Embodiment of the present disclosure are listed below:

(1) The photoelectric part 130 containing the focal plan array and the readout circuit is disposed within the second unit 140.

(2) The transmission medium 160 includes an optical fiber bundle or a mirror with relay optics and an electrical cable, wherein the external optical signal passing through the objective lens 121 is received by the optical device and transmitted to the photoelectric part 130. The cable is used for connecting the processing circuit 141 with its connected display circuit 123 and the display element 122.

(3) The fixing member 110 is connected with a protective cover such as a face mask, and the first unit 120 is disposed on the outside of the face mask.

A method for operating a helmet-mounted visualization device according to a second embodiment of the present disclosure may include the following steps:

(B1) When the fixing member 110 of the helmet-mounted visualization device 100 is worn on a user's head, a power supply 142 of the second unit 140 is turned on.

(B2) The optical device of the first unit 120 receives the external optical signal passing through the objective lens 121 and transmits it to the photoelectric part 130 of the second unit 140, and the photoelectric part 130 converts the external optical signal into an electrical signal and transmits it to the processing circuits 141 and the display circuit 123. The output signal of the processing circuit 141 and the display circuit 123 is transmitted to the display element 122 of the first unit 120 through the cable for displaying external images.

(B3) The connecting member 150 is adjusted in order to adjust a distance and position between the first unit 120 and the second unit 140, and adjust a distance and position between the eye piece and the user's eyes.

(B4) The first unit 120 is moved such that the first 120 won't block the user's vision completely. When the user's eyes observe external images displayed by the display element 122 properly, the connecting member 150 is shaped into a fixed shape, wherein the connecting member 150 is made of a bendable metal material.

### 3^{rd} Embodiment

The differences between the helmet-mounted visualization devices in the 3^{rd} Embodiment and the 1^{st} Embodiment of the present disclosure are listed below:

(1) The fixing member 110 is connected to a protective cover for protecting the user's face.

(2) The transmission medium 160 includes an optical device and a cable, wherein the external optical signal passing through the objective lens 121 is received by the optical device and transmitted to the photoelectric part 130. The cable is used for connecting the processing circuits 141 and the display circuit 123 to the display element 122.

(3) The photoelectric part 130 is disposed within the second unit 140.

(4) The display element 122 with a thin metal case is disposed on the inside of the protective cover and can be moved to the side by a magnet outside of the protective cover, so that the user's eyes will not be blocked when the helmet-mounted visualization device is not in use; and the objective lens 121 and an end of the optical device are disposed on the outside of the protective cover. The external optical signal passing through the objective lens 121 is received by the optical device and transmitted to the photoelectric part 130 within the second unit 140. The objective lens 121 and the end of the optical device are moved with the connecting member 150. The case of the objective lens and the end of the optical device is made by magnetic material, so it can move the display element inside the face mask together.

A method for operating a helmet-mounted visualization device without parallax according to a third embodiment of the present disclosure may include the following steps:

(C1) When the fixing member 110 of the helmet-mounted visualization device 100 is worn on a user's head, a power supply 142 of the second unit 140 is turned on.

(C2) The optical device of the first unit 120 receives the external optical signal passing through the objective lens 121 and transmits it to the photoelectric part 130 of the second unit 140, and the photoelectric part 130 converts the external optical signal into an electrical signal and transmits it to the processing circuits 141 and the display circuit 123. The output signal of the processing circuits 141 and the display circuit 123 is transmitted to the display element 122 of the first unit 120 through the cable for displaying external images.

(C3) A relative position between the connecting member 150, the protective cover, the first unit 120, and the user's head is adjusted in order to adjust a distance between the first unit 120 and the second unit 140. When the user's eyes observe the external images displayed by the display element 122 properly, the connecting member 150 is shaped into a fixed shape.

### 4^{th} Embodiment

The helmet-mounted visualization device without parallax and the method for operating the helmet-mounted visualization device without parallax in the 4^{th} Embodiment are a varied example of the 1^{st} Embodiment applied in a no light or low light environment.

In the 4^{th} Embodiment, the fixing member 110 is a gear on a military helmet, the connecting member 150 is a metal corrugated tube, and the transmission medium 160 is a cable, wherein the transmission medium 160 passes through the metal corrugated tube. The second unit 140 is fixed to a gear or an upper part of the military helmet or the fireman helmet or a head-worn device, and the second unit 140 won't block the user's vision. A housing of the first unit 120 is cylindrical or other shapes, wherein the objective lens 121, the photoelectric part 130, and the display element 122 are sequentially mounted in the housing from the outward to the inward. The central axis of the objective lens 121 is collinear with the central axis of the display element 122 in the front of the user's eyes.

A method for operating a helmet-mounted visualization device without parallax according to a fourth embodiment of the present disclosure may include the following steps:

(D1) When the fixing member 110 (the gear of the military helmet) of the helmet-mounted visualization device 100 is worn on a soldier's head, a power supply 142 of the second unit 140 is turned on.

(D2) The photoelectric part 130 of the first unit 120 converts the external optical signal passing through the objective lens 121 into an electrical signal, and the electrical signal is transmitted to the processing circuits 141 and the display circuit 123 of the second unit 140 through the transmission medium 160 (a cable). The output signal of the processing circuits 141 and the display circuit 123 is transmitted to the display element 122 of the first unit 120 through the transmission medium 160 for displaying external images.

(D3) The first unit 120 is moved downwardly in order to adjust a distance and position between the first unit 120 and the second unit 140 until that a central axis of the objective lens 121 is collinear with a central axis of the display element 122 when the user's gaze is straight. The metal corrugated tube is shaped into a fixed shape in order to fix the relative position between the first unit 120 and the second unit 140. The soldier's eyes can see the external images displayed by the display element 122 in a low light or no light environment at night.

(D4) When the helmet-mounted visualization device is not in use, the first unit 120 is moved upwardly, so that the first unit 120 won't block the soldier's vision.

### 5^{th} Embodiment

The helmet-mounted visualization device without parallax and the method for operating the helmet-mounted visualization device without parallax in the 5^{th} Embodiment are a varied example of the 2^{nd} Embodiment applied in a smoke environment.

In the 5^{th} Embodiment, the fixing member 110 is a gear on a fireman helmet, and the fireman helmet is connected with a protective cover. The connecting member 150 is a metal tube, and the transmission medium 160 includes an optical fiber bundle and a cable, wherein the transmission medium 160 passes through the metal tube, and the optical fiber is a sulfur glass fiber or polycrystalline PIR fiber or other fibers that can pass the infrared light. The second unit 140 is fixed to a gear or an upper part of the fireman helmet, and won't block the fireman's vision. The first unit 120 is disposed in the outside of the protective cover, and a housing of the first unit 120 is cylindrical or other shapes, wherein the objective lens 121 and the display element 122 are sequentially mounted in the housing from the outward to the inward.

A method for operating a helmet-mounted visualization device without parallax according to a fifth embodiment of the present disclosure may include the following steps:

(E1) When the fixing member 110 (the gear of a fireman helmet) of the helmet-mounted visualization device 100 is worn on a fireman's head, a power supply 142 of the second unit 140 is turned on.

(E2) The optical fiber bundle of the first unit 120 receives the external optical signal passing through the objective lens 121 and transmits it to the photoelectric part 130 of the second unit 140, the photoelectric part 130 converts it into an electrical signal to be transmitted to the processing circuits 141 and the display circuit 123 of the second unit 140. The output signal of the processing circuits 141 and the display circuit 123 is transmitted to the display element 122 of the first unit 120 through the transmission medium 160 (a cable) for displaying external images.

(E3) The first unit 120 is moved downwardly in order to adjust a distance and position between the first unit 120 and the second unit 140 until that a central axis of the objective lens 121 is collinear with a central axis of the display element 122 when the fireman's gaze is straight. The metal tube is shaped into a fixed shape in order to fix the relative position between the first unit 120 and the second unit 140. The fireman's eyes can see the external images displayed by the display element 122 in a smoke environment.

(E4) When the helmet-mounted visualization device is not in use, the first unit 120 is pulled upwardly, so that the first unit 120 won't block the fireman's vision.

### 6^{th} Embodiment

The helmet-mounted visualization device without parallax and the method for operating the helmet-mounted visualization device without parallax in the 6^{th} Embodiment are a varied example of the 1^{st} Embodiment applied in temperature measurement.

In the 6^{th} Embodiment, the fixing member 110 is a gear on the helmet. The connecting member 150 is a two-section structure, wherein an upper end of the first section is rotatable and fixed to the helmet, a first end of the second section is connected to the first section through a connecting mechanism, and an angle between the connected positions is adjustable, and a second end of the second section is fixed to the first unit 120. The transmission medium 160 is a cable, and the cable is around the connecting member 150. The second unit 140 is fixed on the upper part of the helmet, and won't block the user's vision. A housing of the first unit 120 is cylindrical or other shapes, wherein the objective lens 121, the photoelectric part 130 and the display element 122 are sequentially mounted in the housing from the outward to the inward. The central axis of the objective lens 121 is collinear with a central axis of the display element 122 when the user's gaze is straight. The processing circuit can obtain the temperature corresponding to the received optical signal according to an optical radiation principle, that is, the temperature distribution.

A method for operating a helmet-mounted visualization device without parallax according to a sixth embodiment of the present disclosure may include the following steps:

(F1) When the fixing member 110 (the gear o a helmet) of the helmet-mounted visualization device 100 is worn on a user's head, a power supply 142 of the second unit 140 is turned on.

(F2) The connecting member 150 is moved downwardly and rotated, the relative angle between the connecting member 150 and the helmet is adjusted, and the relative angle between the first section and the second section is adjusted in order to adjust a distance and position between the first unit 120 and the second unit 140 until that a central axis of the objective lens 121 is collinear with a central axis of the display element 122 when the fireman's gaze is straight. The connecting member 150 is shaped into a fixed shape in order to fix the relative position between the first unit 120 and the second unit 140. The user's eyes can see the external images displayed by the display element 122, wherein the external images contain temperature information.

(F3) When the helmet-mounted visualization device is not in use, the first unit 120 is moved upwardly, so that the first unit 120 won't block the user's vision.

### 7^{th} Embodiment

The helmet-mounted visualization device without parallax and the method for operating the helmet-mounted visualization device without parallax in the 7^{th} Embodiment are a varied example of the 3^{rd} Embodiment applied in a smoke environment.

In the 7^{th} Embodiment, the fixing member 110 is the gear on a fireman helmet, and the fireman helmet is connected with a protective cover. The connecting member 150 is a metal corrugated tube, and the transmission medium 160 includes an optical fiber bundle and a cable, wherein the transmission medium 160 passes through the metal corrugated tube, and the optical fiber is a sulfur glass fiber or polycrystalline PIR fiber or others. The second unit 140 is fixed to an upper part of the fireman helmet, and won't block the fireman's vision. The objective lens 121 and an end of the optical fiber bundle are disposed on the outside of the protective cover, and a housing of the first unit 120 is cylindrical or other shapes, wherein the objective lens 121 and the end of the optical fiber bundle are sequentially mounted in the housing from the outward to the inward. The moveable display element 122 is fixed to the inside of the protective cover.

A method for operating a helmet-mounted visualization device without parallax according to a seventh embodiment of the present disclosure may include the following steps:

(G1) When the fixing member 110 (the gear of a fireman helmet) of the helmet-mounted visualization device 100 is worn on a fireman's head, a power supply 142 of the second unit 140 is turned on.

(G2) The optical fiber bundle of the first unit 120 receives the external optical signal passing through the objective lens 121 and transmits it to the photoelectric part 130 of the second unit 140, the photoelectric part 130 converts it into an electrical signal to be transmitted to the processing circuits 141 and the display circuit 123 of the second unit 140. The output signal of the processing circuits 141 and the display circuit 123 is transmitted to the display element 122 of the first unit 120 through the transmission medium 160 (the cable) for displaying external images.

(G3) The relative position between the fireman helmet and the fireman's head is adjusted, and the protective cover is rotated up and down until that a central axis of the objective lens 121 is collinear with a central axis of the display element 122 when the fireman's gaze is straight. The housing is moved downwardly in order to adjust the relative position between the objective lens 121 and the second unit 140, until that the central axis of the objective lens 121 is collinear with the fireman's vision. The metal corrugated tube is shaped into a fixed shape in order to fix the relative position between the first unit 120 and the second unit 140. The fireman's eyes can see the external images displayed by the display element 122 in a smoke environment.

### 8^{th} Embodiment

The differences between the helmet-mounted visualization device without parallax in the 8^{th} Embodiment with the 2^{nd} Embodiment and the 1^{st} Embodiment of the present disclosure are listed below:

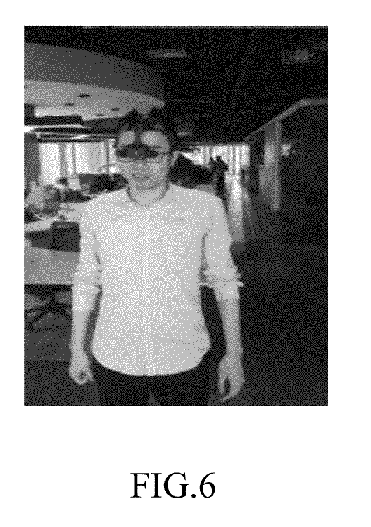

If the IR imager and the LCD/OLED display can be made very small and very thin, we can stack them together and put them in the front of the user's eyes to eliminate parallax. The IR output signal of the processing circuits 141 and the display circuit 123 is transmitted to the display element 122 through the transmission medium 160 (the cable) for displaying external images. If the signal is sent to one display element, the user can use one eye for observation; or if the signal is sent to two display elements the user can use two eyes for observation, see FIG. 6. FIG. 6 is a picture of the helmet-mounted visualization device without parallax and viewed by two eyes (binocular). In addition to the single-eye monocular IR helmet, as shown in FIG. 6, we also developed a binocular IR helmet and the weight is only less than half pound; when the user's eyes down to the ground the IR head will not block his line of sight, he can walk and jump freely.

The above-described embodiments are merely illustrative examples. For example, the connecting member 150 is implemented by a metal tube or a metal corrugated tube, and the fixing member 110 is implemented by a gear of a helmet, a fireman helmet, a military helmet, or a head-worn device. Certainly, other materials can be used for implementing these elements. For example, the connecting member 150 may be implemented by a metal strip, wherein the transmission medium is around the outer edge of the metal strip, and the fixing member may be implemented by a fixing band.

Reference in the specification to “one example” or “an example” means that a particular feature, structure, or characteristic described in connection with the example is included in at least an implementation. The appearances of the phrase “in one example” in various places in the specification are not necessarily all referring to the same example. Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

The above are only preferred examples of the present disclosure is not intended to limit the present disclosure within the spirit and principles of the present disclosure, any changes made, equivalent replacement, or improvement in the protection of the present disclosure should contain within the range.

Those skilled in the art will readily observe that numerous modifications and alterations of the device and method may be made while retaining the teachings of the invention. Accordingly, the above disclosure should be construed as limited only by the meters and bounds of the appended claims.

What is claimed is:

1. A helmet-mounted visualization device without parallax, comprising:
a fixing member, adapted to be worn on a user's head;
a first unit, at least comprising an objective lens and a display element;
a photoelectric part, used for converting an external optical signal passing through the objective lens into an electrical signal and transmitting the electrical signal to a processing circuits;
a second unit, comprising the processing circuits and a power supply, wherein an output end of the processing circuits is coupled to the display element through a transmission medium, and the second unit is disposed on the fixing member;
the photoelectric part can be in the first unit or in the second unit depending on it processes the external signal electrically or optically; and
a connecting member, coupled between the first unit and the second unit;
wherein the connecting member is made of a bendable material or a mechanical device and is shaped into a fixed shape when the central axis of the objective lens is collinear with the central axis of the display element and the user's eyes.

2. The helmet-mounted visualization device without parallax according to claim 1, wherein the photoelectric part comprises a focal plan array and a readout circuit disposed within the first unit, and the electrical signal is transmitted to the processing circuit through the transmission medium.

3. The helmet-mounted visualization device without parallax according to claim 1, wherein the photoelectric part is disposed within the second unit, and the transmission medium comprises:
an optical device with fiber bundle or a mirror with relay optics, wherein the external optical signal passing through the objective lens is received by the optical device and transmitted to the photoelectric part, which contains a focal plan array and a readout circuit; and
a cable, used for connecting the processing circuits and the display element.

4. The helmet-mounted visualization device without parallax according to claim 1, wherein the connecting member is a metal tube, a metal corrugated tube, or a mechanical device, and the transmission medium passes through the metal tube, the metal corrugated tube, or the mechanical device.

5. The helmet-mounted visualization device without parallax according to claim 1, wherein the connecting member is a metal strip or a mechanical device, and the transmission medium is fixed to an outer wall of the connecting member.

6. The helmet-mounted visualization device without parallax according to claim 1, wherein the fixing member is a gear on a military helmet or a fireman helmet or a head-worn device, and the second unit is fixed to the gear or an upper part of the military helmet or the fireman helmet or the head-worn device.

7. The helmet-mounted visualization device without parallax according to claim 6, wherein the military helmet or the fireman helmet or the head-worn device may be connected with a protective cover; the first unit is disposed on the outside of the protective cover, or only the display element is disposed on the inside of the protective cover, in this case, a thin metal case of the display element is moveable by a magnetic envelope of the first unit; the objective lens is disposed on the outside of the protective cover, and the photoelectric part is disposed between the protective cover and the objective lens; or the external optical signal passing through the objective lens is received by an optical device of the transmission medium and transmitted to the photoelectric part within the second unit.

8. The helmet-mounted visualization device without parallax according to claim 7, wherein the moveable display element is fixed on the inside of the protective cover, and the objective lens and the photoelectric part or the optical device is moved with the connecting member; and when the helmet-mounted visualization device is not in use, by moving the connecting member to the side the first unit including the display element inside the protective cover will be moved together by using the magnetic effect.

9. The helmet-mounted visualization device without parallax according to claim 1, wherein the helmet-mounted visualization device is applied for external imaging in a temperature measurement or in a low light, no light, and smoke environment.

10. A method for operating a helmet-mounted visualization device without parallax, the helmet-mounted visualization device comprising a fixing member, a first unit having an objective lens and a display element, a photoelectric part, a second unit having a processing circuit and a power supply, and a connecting member coupled between the first unit and the second unit, and the method comprising:
when the fixing member of the helmet-mounted visualization device is worn on a user's head, turning on a power supply of the second unit;
adjusting the connecting member in order to adjust a distance and position between the first unit and the second unit until that a central axis of the objective lens is collinear with a central axis of the display element when the user's gaze is straight with the central axis; and
when the user's eyes observe external images displayed by the display element, shaping the connecting member into a fixed shape, wherein the connecting member is made of a bendable metal material or a mechanical device.

11. The method according to claim 10, wherein the external images comprise temperature distribution information.

12. The method according to claim 10, wherein the photoelectric part is disposed within the first unit, and the method further comprising:
transmitting the electrical signal to the processing circuit through the transmission medium.

13. The method according to claim 10, wherein the photoelectric part is disposed within the second unit, and the transmission medium comprises an optical device and a cable, and the method further comprising:
receiving the external optical signal passing through the objective lens by the optical device, and transmitting the external optical signal to the photoelectric part; and
using a cable for connecting the processing circuit and the display element.

14. The method according to claim 10, wherein the connecting member is a metal tube or a metal corrugated tube or a mechanical device, and the method further comprising:
passing the transmission medium through the metal tube or the metal corrugated tube, or the mechanical device.

15. The method according to claim 10, wherein the connecting member is a metal strip or a mechanical device, and the method further comprising:
fixing the transmission medium to an outer wall of the connecting member.

16. The method according to claim 10, wherein the fixing member is a gear on a military helmet or a fireman helmet or a head-worn device, and the method further comprising:
fixing the second unit to the gear or an upper part of the military helmet or the fireman helmet or the head-worn device.

17. The method according to claim 16, wherein the military helmet or the fireman helmet or the head-worn device is connected with a protective cover, and the method further comprising:
disposing the first unit on the outside of the protective cover, or disposing the magnetically moveable display element on the inside of the protective cover;
disposing the objective lens on the outside of the protective cover, and disposing the photoelectric part between the protective cover and the objective lens; or
receiving the external optical signal passing through the objective lens by an optical device of the transmission medium, and transmitting the external optical signal to the photoelectric part within the second unit.

18. The method according to claim 17, wherein the display element is fixed on the inside of the protective cover, and the method further comprises:
moving a magnetic case of the objective lens and the photoelectric part or the optical device with the connecting member to the side of the protective cover in order to move the display element inside the protective cover out of the user's eyes when the helmet-mounted visualization device is not in use.

19. The method according to claim 10, wherein the helmet-mounted visualization device is applied for external imaging in a temperature measurement or in a low light, no light, and smoke environment.

20. The method according to claim 10, wherein the display unit will be put little above the user's eyes, when his eyeball moves up a little bit he can see the display, when his eyes look straight or down he can walk or work.

21. The method according to claim 10, wherein when the IR imager can be made very small and thin, the display unit can be put behind to remove the parallax.

22. The method according to claim 10, wherein the IR image can be fused with the visible image picture in picture or pixel by pixel, and the encrypted video and audio with GPS location can be transmitted to the read headquarter by wireless networks, the headquarter also can send the encrypted video and audio to the front soldiers.
